(19) United States
(12) Patent Application Publication
(10) Pub. No.: US 2007/0079116 A1
(43) Pub. Date: Apr. 5, 2007

(54) METHOD, SYSTEM AND COMPUTER PROGRAM PRODUCT FOR ACCESS CONTROL

(75) Inventor: Peter John Johnson, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/463,321

(22) Filed: Aug. 9, 2006

(30) Foreign Application Priority Data
Aug. 11, 2005 (GB) 0516510.5

(51) Int. Cl. H04L 9/00

(52) U.S. Cl. 713/156

(57) ABSTRACT

An access control method for a resource, the resource having associated a current authentication identifier for providing access to the resource, a previous authentication identifier and an incorrect authentication submissions limit, the method being responsive to receiving an authentication submission from an entity requesting access to the resource, wherein the authentication submission does not correspond to the current authentication identifier, the method comprising the steps of: preventing access to the resource by the requester; in response to a determination that the authentication submission does not correspond to the previous authentication identifier, and the incorrect authentication submissions limit is met, causing the current authentication identifier to become revoked; and in response to a determination that the authentication submission does correspond to the previous authentication identifier, maintaining the current authentication identifier for providing access to the resource.

### FIELD OF THE INVENTION

The present invention relates to the field of access control for a resource. In particular, it relates to preventing undesirable revocation of access to a resource.

### BACKGROUND OF THE INVENTION

Access to shared resources can be protected by means of an authentication system using a secret identifier such as a password. Such shared resources can include computer systems with processors, storage devices, databases, software routines, communications facilities or output devices. The identifier can be shared between requester entities such as client computer systems who request access to the resource. Such authentication systems are prone to attack by unauthorised requesters who apply a brute force approach to defeating the authentication. The brute force approach involves requesting access to a resource many times, each time using a different authentication identifier in an attempt to determine the correct identifier. For example, a large number of possible passwords can be automatically generated as varying combinations of allowable characters, and access to the resource can be requested with each password until a correct password is identified.

FIG. 1 is a block diagram of a system for authenticating access to a resource 102 in the prior art. The prior art system of FIG. 1 is suitable for overcoming such brute force attacks as those described above. A requester 112 requests access to the resource 102 by submitting an authentication submission 114, such as a password, to an authenticator 104. The authenticator 104 includes a reference to the resource as resource identifier 106, and a current authentication identifier 108. The current authentication identifier 108 is the identifier which, if supplied by a requester, will result in the authenticator 104 granting access to the resource 102. Any identifier being supplied by a requester other than the current authentication identifier 108 will result in access being refused. This is because only the current authentication identifier 108 can be used to gain access to the resource 102, and it is in this way that the authenticator 104 authenticates authorised accesses to the resource 102. The authenticator 104 further includes a current identifier revoker 110 which is operable to revoke the current authentication identifier 108 when the authenticator receives an authentication submission 114 from the requester 112 which does not match the current authentication identifier 108.

Revocation of the current authentication identifier 108 renders the current authentication identifier 108 ineffective, and prevents future access to the resource 102 until the current authentication identifier 108 is reinstated, such as by a system administrator. In this way, the authenticator 104 overcomes the problem of a brute force attack by preventing access to the resource 102 after an incorrect authentication submission 114 is received. In practice, the current identifier revoker 110 can employ a delayed revocation by requiring that a certain number of requests for access to the resource 102, each with an authentication submission 114 which does not match the current authentication identifier 108, are made before the current authentication identifier 108 is actually revoked. For example, user access control systems which require users to enter passwords to access a computing resource might revoke access to the resource in the event that three incorrect passwords are supplied.

While the system of FIG. 1 as described above provides an effective solution to the problem of brute force attacks on access control systems, there still exists a problem where multiple authorised requesters share a common authentication identifier. If one requester changes the current authentication identifier, other requesters are left with outdated authentication information which will not allow them access to the resource. This is acceptable insofar as only the current authentication identifier should provide access to the resource, but as requesters attempt to access the resource with their outdated, authentication identifiers the current authentication identifier will inevitably become revoked due to the use of incorrect identifiers. This has the undesirable effect of preventing access to the resource by all requesters, including those with up-to-date authentication information. This is not an acceptable outcome, especially in an on-demand computer system where availability of resources is required to be maintained in all but the most extreme of circumstances. It would therefore be advantageous to provide for the continued availability of a resource in the event of a change to an authentication identifier for the resource which renders the authentication information held by authorised requesters of the resource outdated.

### SUMMARY OF THE INVENTION

The present invention may be embodied as an access control method for a resource, the resource having associated a current authentication identifier for providing access to the resource, a previous authentication identifier and an incorrect authentication submissions limit, the method being responsive to receiving an authentication submission from an entity requesting access to the resource where the authentication submission does not correspond to the current authentication identifier. In response to determinations that the authentication submission does not correspond to the previous authentication identifier and the incorrect authentication submissions limit is met, access to the resource is prevents and the current authentication identifier is revoked. In response to a determination that the authentication submission corresponds to the previous authentication identifier, the current authentication identifier is maintained.

In this way, the access control method overcomes the problem of a brute force attack by preventing access to the resource when an incorrect authentication submission is received, except where the incorrect authentication submission is a previously valid authentication identifier for the resource. Thus requesters with outdated authentication information who request access to the resource do not contribute to the revocation of the current authentication identifier, whilst not being able to access the resource themselves. Only requesters with authentication submissions which are not currently, and were not previously, valid contribute to the revocation of the current authentication identifier.

### BRIEF DESCRIPTION OF THE DRAWINGS

A preferred embodiment of the present invention will now be described, by way of example only, with reference to the accompanying drawings, in which:

FIG. 1 is a block diagram of a system for authenticating access to a resource in the prior art;

FIG. 2 is an exemplary block diagram of a computer system suitable for the operation of embodiments of the present invention;

FIG. 3 is an exemplary block diagram of a system for authenticating access to a resource in accordance with a preferred embodiment of the present invention;

FIG. 4 is an exemplary flowchart of a method of the authenticator of FIG. 3 for providing authorised requesters with access to a resource in accordance with a preferred embodiment of the present invention;

FIG. 5 is an exemplary block diagram of an exemplary current identifier revoker in accordance with a preferred embodiment of the present invention;

FIG. 6 is an exemplary flowchart of a method of the current identifier revoker of FIG. 4 in accordance with a preferred embodiment of the present invention;

FIG. 7 is an exemplary flowchart of a method of the authenticator of FIG. 3 for an authorised requester to change the current authentication identifier in accordance with a preferred embodiment of the present invention;

FIG. 8a is a first exemplary block diagram of a server computer system including an authenticator and a resource in accordance with a preferred embodiment of the present invention;

FIG. 8b is a flow diagram illustrating the flow of requests between the client systems and the server computer system of FIG. 8a in accordance with a preferred embodiment of the present invention;

FIG. 9a is a second exemplary block diagram of a server computer system including an authenticator and a resource in accordance with a preferred embodiment of the present invention; and

FIG. 9b is a flow diagram illustrating the flow of requests between the client systems and the server computer system of FIG. 9a in accordance with a preferred embodiment of the present invention.

### DETAILED DESCRIPTION OF THE PREFERRED EMBODIMENTS

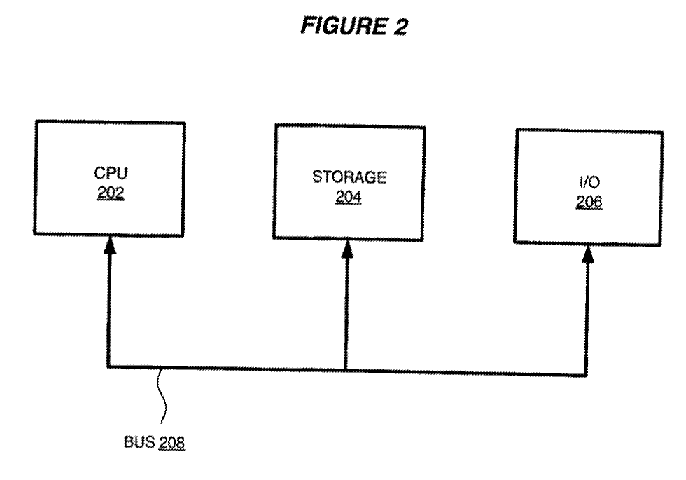

FIG. 2 is a block diagram of a computer system suitable for the operation of embodiments of the present invention. A central processor unit (CPU) 202 is communicatively connected to a storage 204 and an input/output (I/O) interface 206 via a data bus 208. The storage 204 can be any read/write storage device such as a random access memory (RAM) or a non-volatile storage device. An example of a non-volatile storage device includes a disk or tape storage device. The I/O interface 206 is an interface to devices for the input or output of data, or for both input and output of data. Examples of I/O devices connectable to I/O interface 206 include a keyboard, a mouse, a display (such as a monitor) and a network connection.

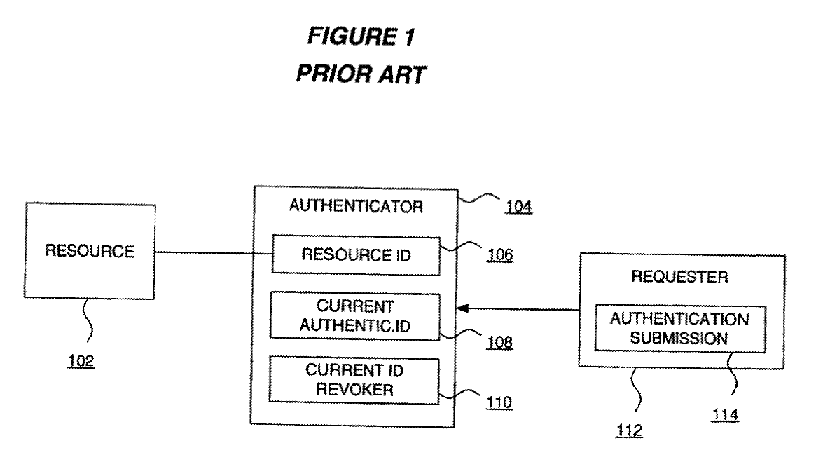

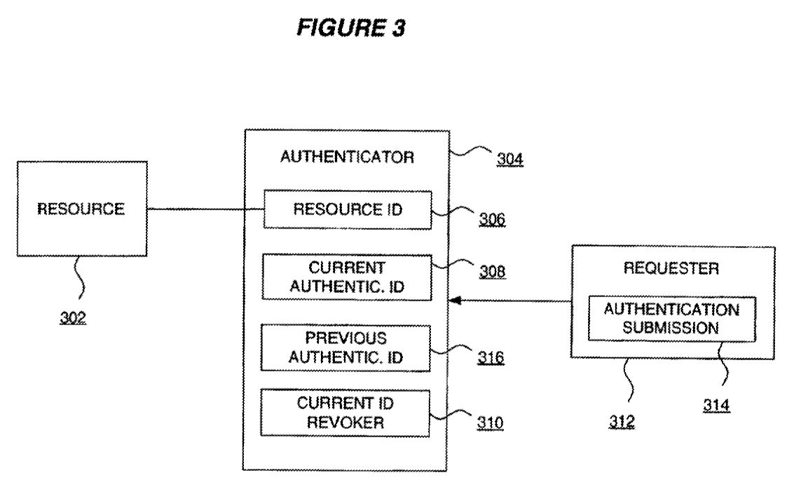

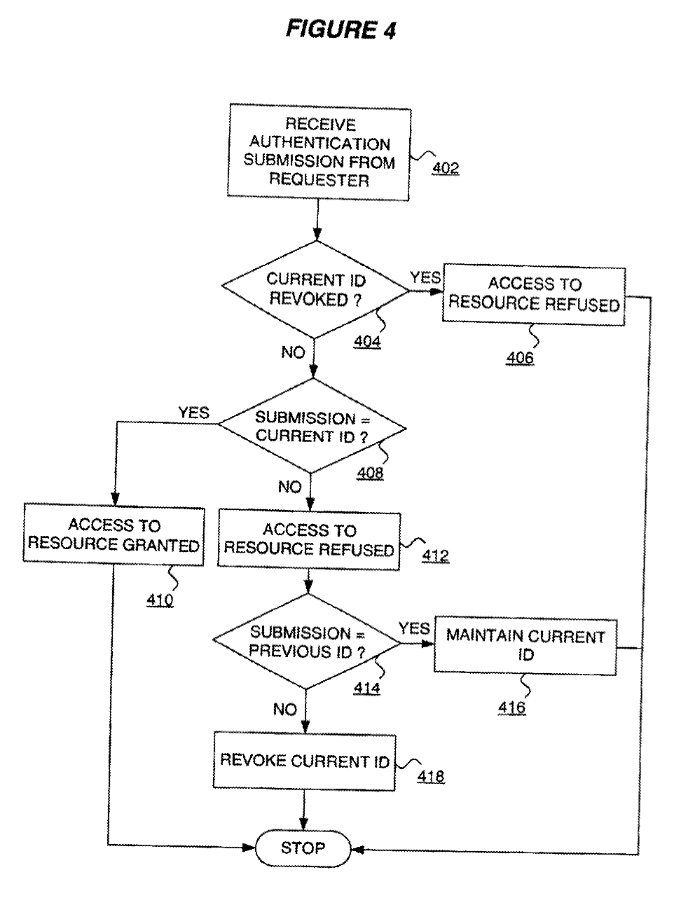

FIG. 3 is an exemplary block diagram of a system for authenticating access to a resource 302 in accordance with a preferred embodiment of the present invention. Many of the elements of FIG. 3 are identical to those described above with respect to FIG. 1 and these will not be repeated here. The authenticator 304 of FIG. 3 further includes a previous authentication identifier 316, which is a copy of a previously valid authentication identifier. For example, requester 312 can request to change a value of the current authentication identifier 308, such as by changing a password. Before the new value is assigned to the current authentication identifier 308, the existing value is recorded in the previous authentication identifier 316. The operation of the authenticator 304 of FIG. 3 differs from that of the prior art as will be apparent below in this description, in particular with respect to FIG. 4. In general terms, the authenticator 304 uses the current identifier revoker 310 to revoke the current authentication identifier 308 in the event that the authentication submission 314 from the requester 312 does not match the current authentication identifier 308 or the previous authentication identifier 316. In this way, requests of the requester 312 which include an authentication submission 314 matching either the current authentication identifier 308 or previous authentication identifier 316 do not result in the current identifier revoker 310 revoking the current authentication identifier 308. Consequently, the resource 302 continues to be available to requesters through the valid current authentication identifier 308 even where incorrect authentication submissions are made by requesters as long as the authentication submissions correlate to the previous authentication identifier 316. Thus, in an environment where there are multiple requesters, if one requester changes the current authentication identifier 308, access requests from the other requesters with outdated authentication information will not result in the revocation of the current authentication identifier 308. At the same time, the current authentication identifier 308 is revoked where identifiers are supplied which match neither the current or previous authentication identifiers 308, 316.

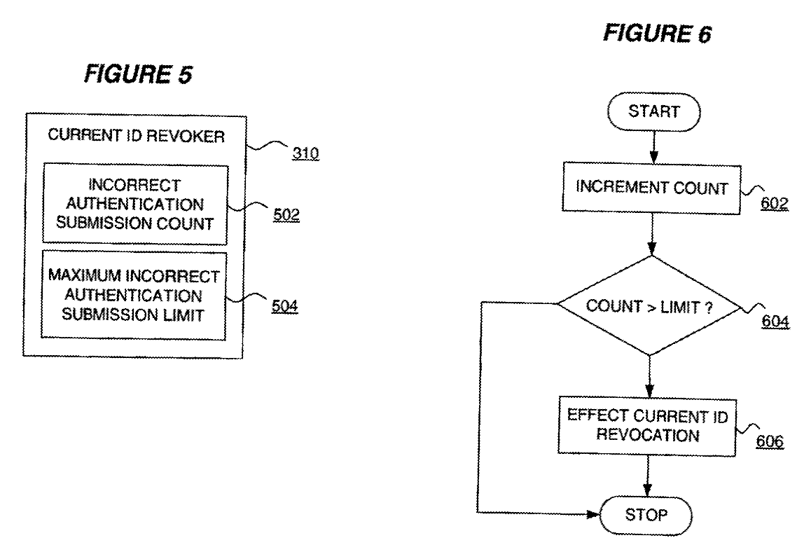

FIG. 4 is an exemplary flowchart of a method of the authenticator 304 of FIG. 3 for providing authorised requesters with access to a resource in accordance with a preferred embodiment of the present invention. At step 402, authenticator 304 receives the authentication submission 314 from the requester 312. At step 404 the authenticator 304 determines if the current authentication identifier 308 is currently-revoked (e.g. as a result of previous requests from requesters with incorrect identifiers). Information relating to the revoked status of the current authentication identifier 308 can be kept in a storage medium private to the authenticator 304 such as a memory, disk or other storage medium. If the current authentication identifier 308 is revoked, the method refuses access to the resource 302 at step 406 and terminates. If the current authentication identifier 308 is not revoked, the method determines if the value of the authentication submission 314 matches that of the current authentication identifier 308 at step 408, and if they do match, grants access to the resource 302 at step 410 and terminates. If the value of the authentication submission 314 does not match that of the current authentication identifier 308, step 412 refuses access to the resource 302. At step 414 the method determines if the value of the authentication submission 314 matches that of the previous authentication identifier 316, and if they do match, proceeds to step 416 where the current authentication identifier 308 is maintained (i.e. it is not revoked) and the method terminates. If step 414 determines that the value of the authentication submission 314 does not match that of the previous authentication identifier 316, step 418 revokes the current authentication identifier 308 by means of the current identifier revoker 310. Alternatively, at the step 418, the current identifier revoker 310 can employ a delayed revocation by requiring that a certain number of requests for access to the resource 302, each with an authentication submission 114 which does not match either the current authentication identifier 108 or the previous authentication identifier 316, are made before the current authentication identifier 308 is actually revoked. Such a current identifier revoker 310 is described below with reference to FIG. 5 and 6.

FIG. 5 is an exemplary block diagram of an exemplary current identifier revoker 310 in accordance with a preferred embodiment of the present invention. The current identifier revoker 310 is a software or hardware component for rendering the current authentication identifier 308 ineffective, and thus preventing the requester 312 from having access to resource 302. The current identifier revoker 310 of FIG. 5 includes an incorrect authentication submission count 502 and a maximum incorrect authentication submission limit 504. The current identifier revoker 310 of FIG. 5 only revokes the current authentication identifier 308 when a number of requests to access the resource 302 with an authentication submission 314 which does not match either the current or previous authentication identifiers 308, 316 exceed the maximum incorrect authentication submission limit 504. The number of such unsuccessful requests is recorded in the incorrect authentication submission count 502.

FIG. 6 is an exemplary flowchart of a method of the current identifier revoker 310 of FIG. 4 in accordance with a preferred embodiment of the present invention. The method is used when at step 418 of FIG. 4 to revoke the current authentication identifier 308. At step 603 the incorrect authentication submission count 502 is incremented and at step 604 the incorrect authentication submission count 502 is compared to the maximum incorrect authentication submission limit 504. If the incorrect authentication submission count 502 is greater than the maximum incorrect authentication submission limit 504 then the method causes revocation of the current authentication identifier 308 at step 606 before terminating.

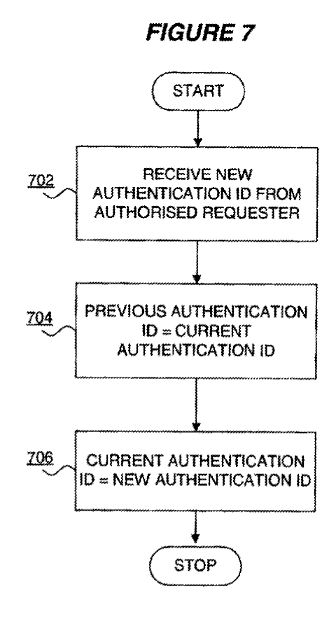

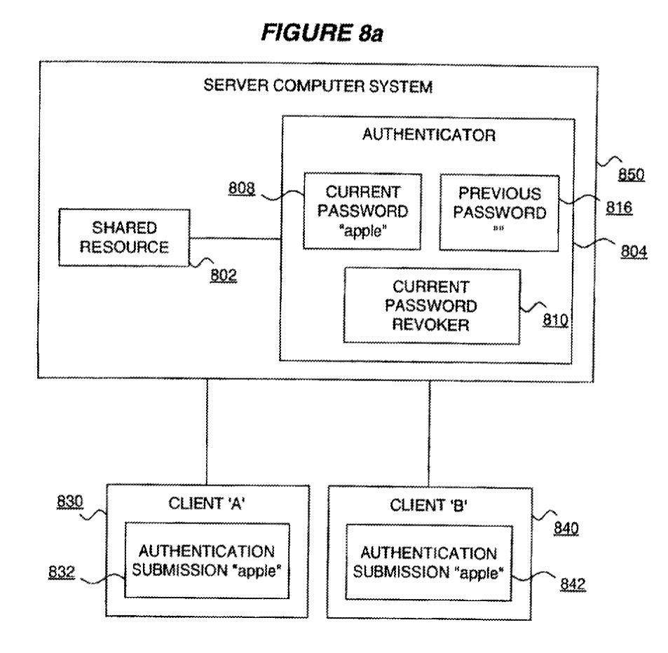

FIG. 7 is an exemplary flowchart of a method of the authenticator 304 of FIG. 3 for an authorised requester 312 to change the current authentication identifier 308 in accordance with a preferred embodiment of the present invention. An authorised requester (i.e. a requester who provides an authentication submission 314 having a value which matches a value of the current authentication identifier 308) is able to request that the authenticator change the value of the current authentication identifier 308 to a new value. At step 702, a new value of the current authentication identifier 308 is received by the authenticator. At step 704 the existing value of the current authentication identifier 308 is recorded as a new value of the previous authentication identifier 316. At step 706 the new value of the current authentication identifier 308 is recorded in the current authentication identifier 308. In this way, the value of the current authentication identifier 308 is changed while retaining an existing value in the previous authentication identifier 316.

Alternatively, the authenticator 304 can record a series of historical values of the current authentication identifier 308 in the previous authentication identifier 316. For example, the previous authentication identifier 316 can be a data structure such as a list, table or database of multiple previous values of the current authentication identifier 308.

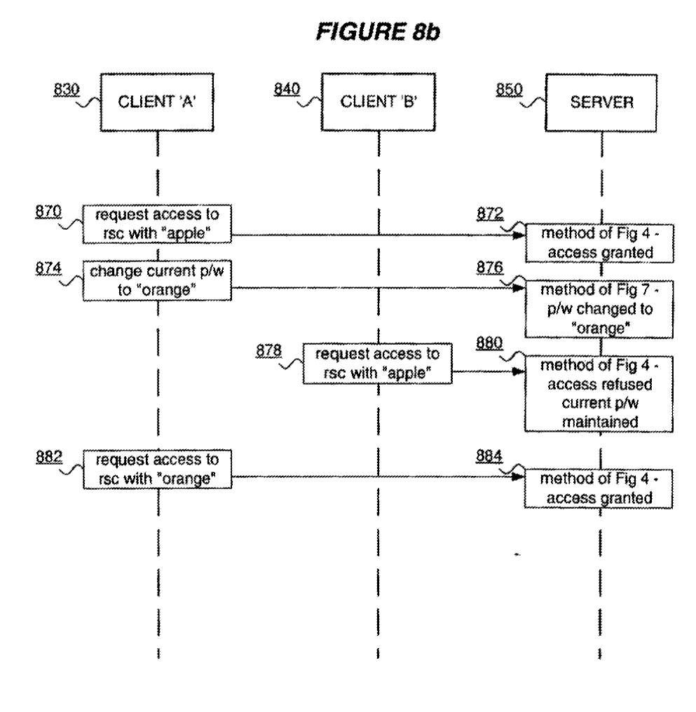

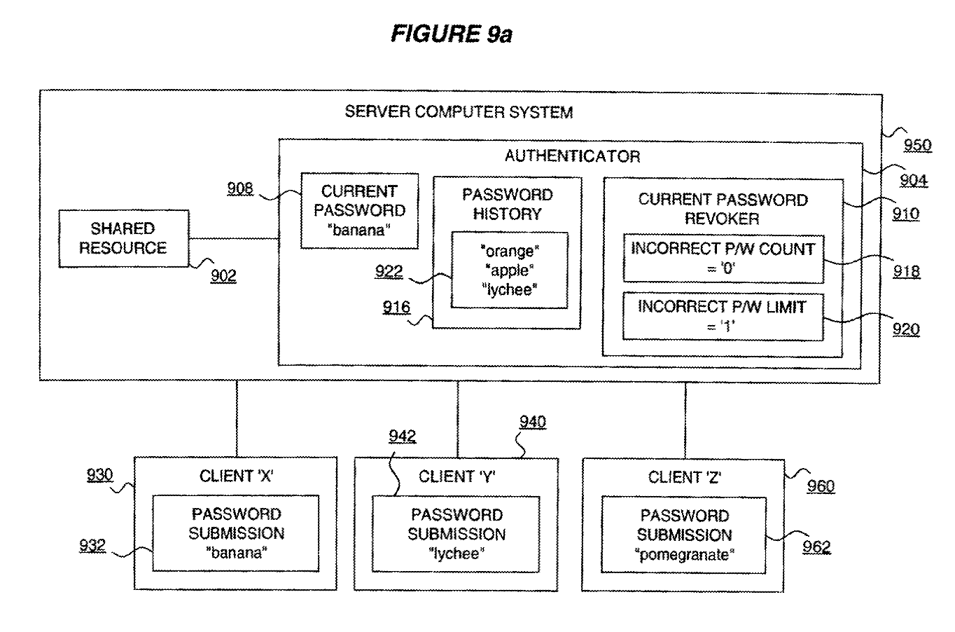

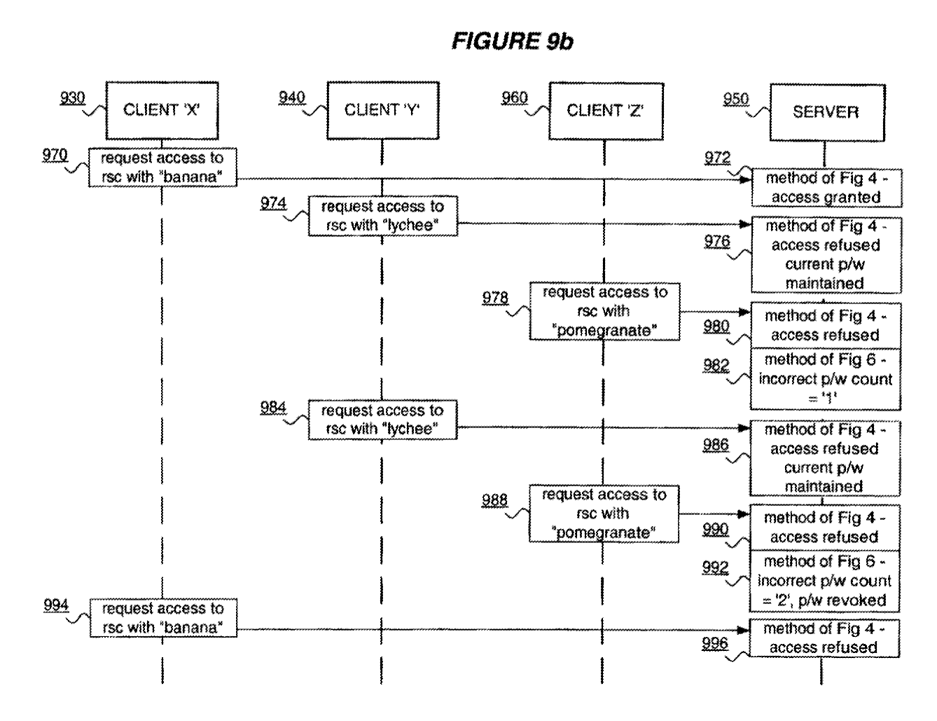

Preferred embodiments of the present invention shall now be considered in use by way of example only with reference to a first exemplary arrangement in FIG. 8a and a second exemplary arrangement in FIG. 9a.

FIG. 8a is a first exemplary block diagram of a server computer system 850 including an authenticator 804 and a resource 802 in accordance with a preferred embodiment of the present invention. The authenticator 804 of the server computer system 850 is associated with the shared resource 802 and includes a current password 808 having a value of “apple” and a previous password 816 having no initial value. The authenticator also includes a current password revoker 810, which can be equivalent in function to any of the current identifier revokers considered hereinbefore. Two client systems named ‘A’ 830 and ‘B’ 840 are communicatively connected to the server computer system 850. For example, client systems 830 and 840 can be client computer systems, handheld devices, terminals, or other entities which request the use of the shared resource 802. Alternatively, the client systems 830 and 840 could conceivably form part of the server computer system 850 itself, such as separate software modules within the server computer system. The communicative connection between the client systems 830, 840 and the server computer system 850 can be a wired or wireless computer network, a software link, for example. Both client systems ‘A’ 830 and ‘B’ 840 send authentication submissions 832, 842 having the value “apple”. FIG. 8b is a flow diagram illustrating the flow of requests between the client systems 830, 840 and the server computer system 850 of FIG. 8a in accordance with a preferred embodiment of the present invention. Initially, at step 870, client ‘A’ 830 submits a request to the server 850 for access to the resource 802 using the authentication submission 832 having the value “apple”. At step 872, the server employs the method of FIG. 4 as follows. At step 402 the authentication 804 receives the authentication submission “apple” from client ‘A’ 830. At step 404 the authenticator 804 determines that the current password 808 is not revoked. At step 408 the authenticator determines that the authentication submission 832 “apple” matches the current password 808 “apple” and access to the shared resource 802 is granted to client ‘A’ 830 at step 410.

Returning to FIG. 8b, subsequently at step 874 client ‘A’ 830 requests to change the value of the current password 808 to “orange”. At step 876 the server 850 employs the method of FIG. 7 to change the current password 808. At step 702 the authenticator 804 receives the new password “orange” from client ‘A’ 830. At step 704 the authenticator assigns the existing value of the current password 808 to the previous password 816. Thus, following step 704 the previous password 816 has the value “apple”. Finally, at step 706, the authenticator updates the value of the current password 808 to the new value “orange”. In this way, client ‘A’ 83O has effected a change in the value of the current password 808, and client ‘A’ also effects this change in the value of its own authentication submission 832 in order to ensure client ‘A’ 830 can continue to access the shared resource 802 in future. However, client ‘B’ 840 has not been notified of this change in the value of the current password 808 and so the value of the authentication submission 842 of client ‘B’ 840 is now outdated.

Retuning to FIG. 8b, subsequently at step 878 client ‘B’ 840 requests access to the shared resource 802 with the authentication submission 842 having the value “apple”. At step 880 the server employs the method of FIG. 4 as follows. At step 402 the authenticator 804 receives the authentication submission “apple” from client ‘B’ 840. At step 404 the authenticator 804 determines that the current password 808 is not revoked. At step 408 the authenticator determines that the authentication submission 842 “apple” does not match the current password 808 “orange” (as modified by client ‘A’ 830 at step 874). The method thus proceeds to step 412 where access to the shared resource 802 for client ‘B’ 840 is refused. At step 414 the method determines that the authentication submission 842 “apple” does match the previous password 816 “apple” and at step 416 the current password 808 is maintained. Thus, whilst client ‘B’ 840 is not able to access the shared resource 802 since the password provided by client ‘B’ 840 (the authentication submission 842) does not match the current password 808, the current password 808 is not revoked because the authentication submission 842 provided by client ‘B’ 840 matches the previous password 816. Returning to FIG. 8b, subsequently at step 882 client ‘A’ 830 once again requests access to the shared resource 802 with the authentication submission 832 this time having the value “orange”. At step 872, the server employs the method of FIG. 4 as follows. At step 402 the authenticator 804 receives the authentication submission “orange” from client ‘A’ 830. At step 404 the authenticator 804 determines that the current password 808 is not revoked. At step 408 the authenticator determines that the authentication submission 832 “orange” matches the current password 808 “orange” and access to the shared resource 802 is granted to client ‘A’ 830 at step 410. Thus, despite the earlier unsuccessful request of client ‘B’ 840 to access the shared resource 802, client ‘A’ 830 can continue to access the shared resource 802. This is because the current password 808 is not revoked where an incorrect password is used if it corresponds to a previously valid password, i.e. the previous password 816.

FIG. 9a is a second exemplary block diagram of a server computer system including an authenticator 904 and a resource 902 in accordance with a preferred embodiment of the present invention. The authenticator 904 of the server computer system 950 is associated with the shared resource 902 and includes a current password 908 having a value of “banana” and a password history 916 having three previous passwords with values of “orange”, “apple” and “lychee”. The authenticator 904 also includes a current password revoker 910 which includes an incorrect password count 918 and an incorrect password limit 920. Initially, the incorrect password count 918 has a value of ‘0,’ and the incorrect password limit has a value of ‘1’. Three client systems named ‘X’ 930, ‘Y’ 940 and ‘Z’ 960 are communicatively connected to the server computer system 850. For example, client systems 930, 940 and 960 can be client computer systems, handheld devices, terminals, or other entities which request the use of the shared resource 802. Alternatively, the client systems 930, 940 and 960 could conceivably form part of the server computer system 850 itself, such as separate software modules within the server computer system. The communicative connection between the client systems 930, 940, 960 and the server computer system 950 can be a wired or wireless computer network, for example. Client system ‘X’ includes a password submission 932 having a value “banana”. Client system ‘Y’ includes a password submission 942 having a value “lychee”. Client system ‘Z’ includes a password submission 962 having a value “pomegranate”.

FIG. 9b is a flow diagram illustrating the flow of requests between the client systems 930, 940, 960 and the server computer system 950 of FIG. 9a in accordance with a preferred embodiment of the present invention. Initially, at step 970, client ‘X’ 930 submits a request to the server 950 for access to the resource 902 using the password submission 932 having the value “banana”. At step 972, the server 950 employs the method of FIG. 4 as follows. At step 402 the authenticator 904 receives the password submission “banana” from client ‘X’ 930. At step 404 the authenticator 904 determines that the current password 908 is not revoked. At step 408 the authenticator 904 determines that the authentication submission 932 “banana” matches the current password 908 “banana” and access to the shared resource 902 is granted to client ‘X’ 930 at step 410.

Returning to FIG. 9b, subsequently at step 974 client ‘Y’ 940 requests access to the shared resource 902 with the password submission 942 having the value “lychee”. At step 976 the server employs the method of FIG. 4 as follows. At step 402 the authenticator 904 receives the authentication submission 942 “lychee” from client ‘Y’ 940. At step 404 the authenticator 904 determines that the current password 908 is not revoked. At step 408 the authenticator determines that the authentication submission 942 “lychees” does not match the current password 908 “banana”. The method thus proceeds to step 412 where access to the shared resource 902 for client ‘Y’ 940 is refused. At step 414 the method determines that the authentication submission 942 “lychee” does match the one of the previous passwords stored in the password history 916 and at step 416 the current password 908 is maintained. Thus, whilst client ‘Y’ 940 is not able to access the shared resource 902 since the password provided by client ‘Y’ 940 (the authentication submission 942) does not match the current password 908, the current password 908 is not revoked because the authentication submission 942 provided by client ‘Y’ 940 matches a previous password stored in the password history 916.

Returning to FIG. 9b, subsequently at step 978 client ‘Z’ 960 requests access to the shared resource 902 with the password submission 962 having the value “pomegranate”. At step 980 the server employs the method of FIG. 4 as follows. At step 402 the authenticator 904 receives the authentication submission 962 “pomegranate” from client ‘Z’ 960. At step 404 the authenticator 904 determines that the current password 908 is not revoked. At step 408 the authenticator 904 determines that the authentication submission 962 “pomegranate” does not match the current password 908 “banana”. The method thus proceeds to step 412 where access to the shared resource 902 for client ‘Z’ 960 is refused. At step 414 the method determines that the authentication submission 962 “pomegranate” does not match any of the previous passwords stored in the password history 916 and at step 418 the current password 908 is revoked. Returning to FIG. 9b, at step 982 the server 950 employs the method of FIG. 6 to effect gradual revocation of the current password 908 as follows. At step 602 the incorrect password count 918 is incremented from a value of ‘0’ to a value of ‘1’. At step 604 the method determines that the value of the incorrect password count 918 of ‘1’ is not greater than the value of the incorrect password limit 920 of ‘1’ and so the method of FIG. 6 terminates.

Returning to FIG. 9b, subsequently at step 984 client ‘Y’ 940 once more requests access to the shared resource 902 with the password submission 942 having the value “lychee”. At step 986 the server once again employs the method of FIG. 4 as follows. At step 402 the authenticator 904 receives the authentication submission 942 “lychee” from client ‘Y’ 940. At step 404 the authenticator 904 determines that the current password 908 is not revoked. At step 408 the authenticator determines that the authentication submission 942 “lychee” does not match the current password 908 “banana”. The method thus proceeds to step 412 where access to the shared resource 902 for client ‘Y’ 940 is refused. At step 414 the method determines that the authentication submission 942 “lychee” does match the one of the previous passwords stored in the password history 916 and at step 416 the current password 908 is maintained. Thus, while client ‘Y’ 940 is not able to access the shared resource 902 since the password provided by client ‘Y’ 940 (the authentication submission 942) does not match the current password 908, the current password 908 is not revoked because the authentication submission 942 provided by client ‘Y’ 940 matches a previous password stored in the password history 916.

Returning to FIG. 9b, subsequently at step 988 client ‘Z’ 960 once again requests access to the shared resource 902 with the password submission 962 having the value “pomegranate”. At step 990 the server once again employs the method of FIG. 4 as follows. At step 402 the authenticator 904 receives the authentication submission 962 “pomegranate” from client ‘Z’ 960. At step 404 the authenticator 904 determines that the current password 908 is not revoked. At step 408 the authenticator 904 determines that the authentication submission 962 “pomegranate” does not match the current password 908 “banana”. The method thus proceeds to step 412 where access to the shared resource 902 for client ‘Z’ 960 is refused. At step 414 the method determines that the authentication submission 962 “pomegranate” does not match any of the previous passwords stored in the password history 916 and at step 418 the current password 908 is revoked. Returning to FIG. 9b, at step 992 the server 950 once again employs the method of FIG. 6 to effect gradual revocation of the current password 908 as follows. At step 602 the incorrect password count 918 is incremented from a value of ‘1’ to a value of ‘2’. At step 604 the method determines that the value of the incorrect password counts 918 of ‘2’ is greater than the value of the incorrect password limit 920 of ‘1’. Consequently, at step 606 revocation of the current password 908 is effected to prevent all future access to the shared resource 902.

Through this repetition at steps 974, 978, 984 and 988 of FIG. 9b it can be seen that the requests from client ‘Y’ 940 using a password submission 942 of “lychee” which exists in the password history 916 does not result in revocation of the current password 908. In contrast, the requests from client ‘Z’ 960 using a password submission 962 of “pomegranate” which does not exist in the password history 916 does result in revocation of the current password 908. Returning once more to FIG. 9b, at step 994, client ‘X’ 930 once more submits a request to the server 950 for access to the resource 902 using the password submission 932 having the value “banana”. At step 996, the server 950 employs the method of FIG. 4 as follows. At step 402 the authenticator 904 receives the password submission “banana” from client ‘X’ 930. At step 404 the authenticator 904 determines that the current password 908 is revoked, and at step 406 access to the resource 902 is refused.

Thus, due to the revocation of the current password 908 resulting from the unsuccessful access attempts made previously by client ‘Z’ 960, all clients including those with correct password submissions such as client ‘X’ 930 are prevented from accessing the shared resource 902.

In this way the authenticator 904 is able to protect against brute force attacks using many automatically generated passwords while still providing access to the shared resource 902 in the event that other clients use outdated password information.

1. An access control method for a resource, the resource having associated a current authentication identifier for providing access to the resource, a previous authentication identifier and an incorrect authentication submissions limit, the method being responsive to receiving an authentication submission from an entity requesting access to the resource, wherein the authentication submission does not correspond to the current authentication identifier, the method comprising the steps of:
preventing access to the resource by the requester;
in response to a determination that the authentication submission does not correspond to the previous authentication identifier, and the incorrect authentication submissions limit is met, causing the current authentication identifier to become revoked; and
in response to a determination that the authentication submission does correspond to the previous authentication identifier, maintaining the current authentication identifier for providing access to the resource.

2. The method of claim 1 wherein the incorrect authentication submissions limit corresponds to a single determination that the authentication submission does not correspond to the previous authentication identifier.

3. The method of claim 1 wherein the current authentication identifier is a current password for the resource; the previous authentication identifier is a previous password for the resource; and the authentication submission is a password submission.

4. The method of claim 1 wherein the resource has further associated an incorrect authentication submission count, and causing the current authentication identifier to become revoked comprises the steps of:
updating the incorrect authentication submission count; and
in response to a determination that the incorrect authentication submission count has reached the incorrect authentication submissions limit, preventing access to the resource by way of the current authentication identifier.

5. The method of claim 1 wherein resource is a server entity and the requester is a client entity.

6. The method of claim 1 wherein the entity requesting access to the resource is one of a set of entities, and the current authentication identifier is common to all entities in the set of entities.

7. The method of claim 6 wherein the current authentication identifier is confidential to the set of entities.

8. A system for providing access control for a resource, the resource having associated a current authentication identifier for providing access to the resource, a previous authentication identifier and an incorrect authentication submissions limit, the method being responsive to receiving an authentication submission from an entity requesting access to the resource, wherein the authentication submission does not correspond to the current authentication identifier, the system comprising:
means for preventing access to the resource by the requester;
means responsive to a determination that the authentication submission does not correspond to the previous authentication identifier, and the incorrect authentication submissions limit is met, for causing the current authentication identifier to become revoked; and
means responsive to a determination that the authentication submission does correspond to the previous authentication identifier, for maintaining the current authentication identifier for providing access to the resource.

9. The system of claim 8 wherein the incorrect authentication submissions limit corresponds to a single determination that the authentication submission does not correspond to the previous authentication identifier.

10. The system of claim 8 wherein the current authentication identifier is a current password for the resource; the previous authentication identifier is a previous password for the resource; and the authentication submission is a password submission.

11. The system of claim 8 wherein the resource has further associated an incorrect authentication submission count, and the means for causing the current authentication identifier to become expired further comprises:
means for updating the incorrect authentication submission count; and means responsive to a determination that the incorrect authentication submission count has reached the incorrect authentication submissions limit, for preventing access to the resource by way of the current authentication identifier.

12. The system of claim 8 wherein resource is a server entity and the requester is a client entity.

13. The system of claim 8 wherein the entity requesting access to the resource is one of a set of entities, and the current authentication identifier is common to all entities in the set of entities.

14. The system of claim 13 wherein the current authentication identifier is confidential to the set of entities.

15. A computer program product comprising a computer readable media embodying computer program instructions that, when executed on a computer, cause the computer to perform an access control method for a resource, the resource having associated a current authentication identifier for providing access to the resource, a previous authentication identifier and an incorrect authentication submissions limit, the method being responsive to receiving an authentication submission from an entity requesting access to the resource, wherein the authentication submission does not correspond to the current authentication identifier, the method comprising the steps of:
preventing access to the resource by the requester;
in response to a determination that the authentication submission does not correspond to the previous authentication identifier, and the incorrect authentication submissions limit is met, causing the current authentication identifier to become revoked; and
in response to a determination that the authentication submission does correspond to the previous authentication identifier, maintaining the current authentication identifier for providing access to the resource.
